(19) United States
(12) Patent Application Publication
(10) Pub. No.: US 2024/0350879 A1
(43) Pub. Date: Oct. 24, 2024

(54) GOLF CADDY SYSTEM

(71) Applicant: Matthew Zdunich, Waterdown (CA)

(72) Inventor: Matthew Zdunich, Waterdown (CA)

(21) Appl. No.: 18/136,691

(22) Filed: Apr. 19, 2023

(51) Int. Cl. A63B 55/60; A63B 24/00; A63B 71/06; B62B 3/10; B62B 5/00; B64U 10/14; B64U 50/20; B64U 50/30; G05D 1/02; G05D 1/10; G06T 7/70; G06V 20/17; G06V 20/40; G06V 40/20; G10L 15/22; H04N 5/91; H04N 23/57; H04R 1/02

(52) U.S. Cl. CPC A63B 55/61; A63B 24/0006; A63B 24/0021; A63B 71/0622; B62B 3/102; B62B 5/00; B62B 5/004; B62B 5/0043; B62B 5/0069; B64U 10/14; B64U 50/20; B64U 50/30; G06T 7/70; G06V 20/17; G06V 20/42; G06V 40/23; G10L 15/22; H04N 5/91; H04N 23/57; H04R 1/028; A63B 2024/0028; A63B 2071/0625; A63B 2220/05; A63B 2220/806; A63B 2225/50; B62B 2202/406; B64U 2101/30; G06T 2207/10016; G06T 2207/10032; G06T 2207/30224; G10L 2015/223

(57) ABSTRACT

A golf caddy system for autonomously carrying a golf bag across a golf course, recording video of golf swings, and providing golfing advice to a user includes an autonomous motorized cart. The cart includes a processor with map data of the golf course in a memory of the processor and a global positioning system receiver for determining a current location of the cart. The cart also includes a camera which is configured to capture video of a golf swing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to golf caddy devices and systems and more particularly pertains to a new golf caddy system for autonomously carrying a golf bag across a golf course, recording video of golf swings, and providing golfing advice to a user.

### (2) Description of Related Art including information disclosed under 37 CFR 1.97 and 1.98

The prior art discloses myriad golf caddy devices and systems which perform various functions, including manually or autonomously carrying a golf bag across a golf course, providing golfing advice to a user, tracking golf scores, tracking the location of a golfer on a golf course, displaying suggested putt paths, and the like. However, the prior art does not disclose a system which synthesizes these functions together into an autonomously moving cart that carries a golf bag, identifies a location of a struck ball based on recorded video and map data, records video of golf swings, analyzes the videos to determine golf swing information and golfer advice, and displays suggested putt paths, among other functions. The prior art also fails to describe a system including the above cart and a cooperating unmanned aerial vehicle which records video of golf swings, emits laser light in a path between a user and a target hole, and measures topographical information related to the golf course.

### BRIEF SUMMARY OF THE INVENTION

An embodiment of the disclosure meets the needs presented above by generally comprising a cart comprising a frame and a cart drive mechanism that is coupled to the frame and is operable to move the cart across a ground surface. A cart processor with a memory is mounted to the frame and is electrically coupled to the cart drive mechanism. A map data is stored on the memory and includes location and topographical information of a golf course. A global positioning system (GPS) receiver is electrically coupled to the cart processor and is configured to determine a current location of the cart. The cart processor is configured to cause the cart drive mechanism to move the cart to a selected location on the golf course based on the map data and the current location of the cart. A cart camera is coupled to the frame and is electrically coupled to the cart processor. The cart camera is configured to capture a first video of a golf swing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top back side perspective view of a golf caddy system according to an embodiment of the disclosure.

FIG. 2 is a side view of an embodiment of the disclosure.

FIG. 3 is a front view of an embodiment of the disclosure.

FIG. 4 is a top view of an embodiment of the disclosure.

FIG. 5 is a block diagram of an embodiment of the disclosure.

FIG. 6 is an in-use view of an embodiment of the disclosure.

FIG. 7 is an in-use view of an unmanned aerial vehicle of an embodiment of the disclosure.

### DETAILED DESCRIPTION OF THE INVENTION

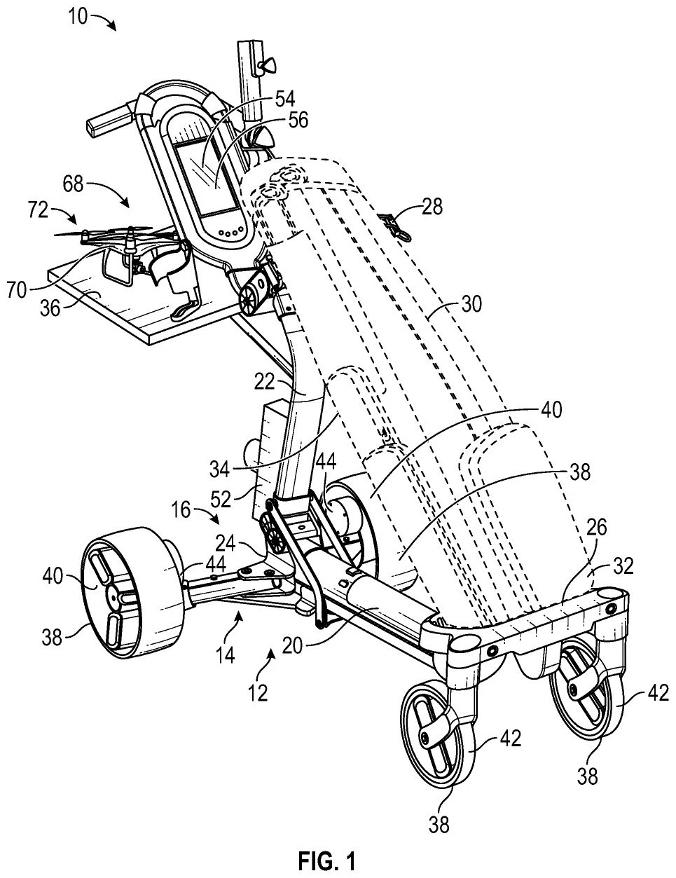

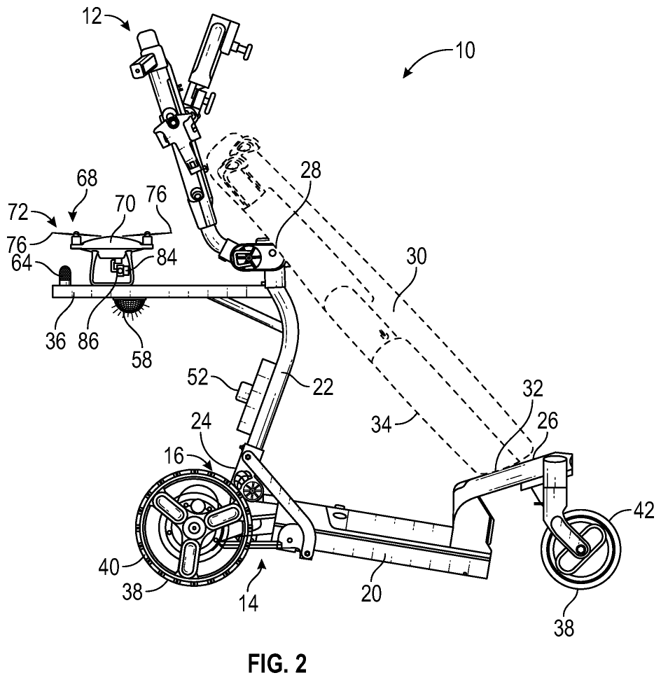

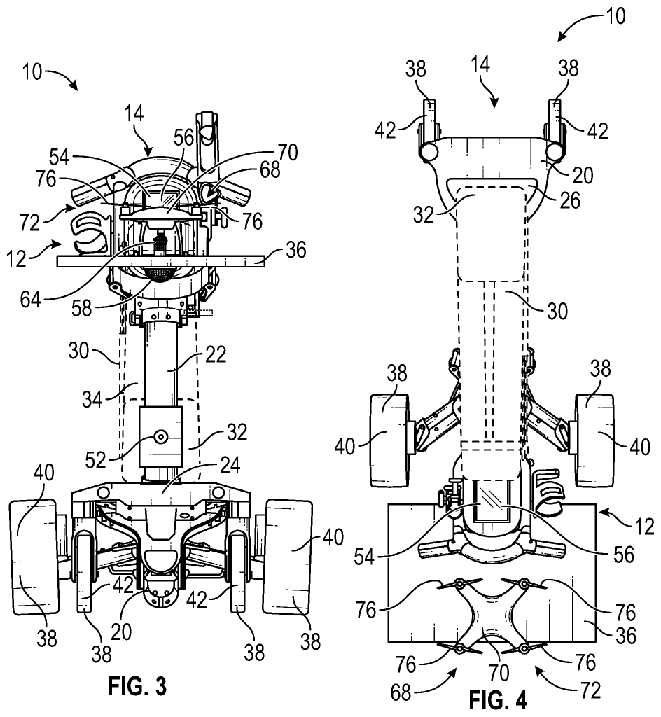

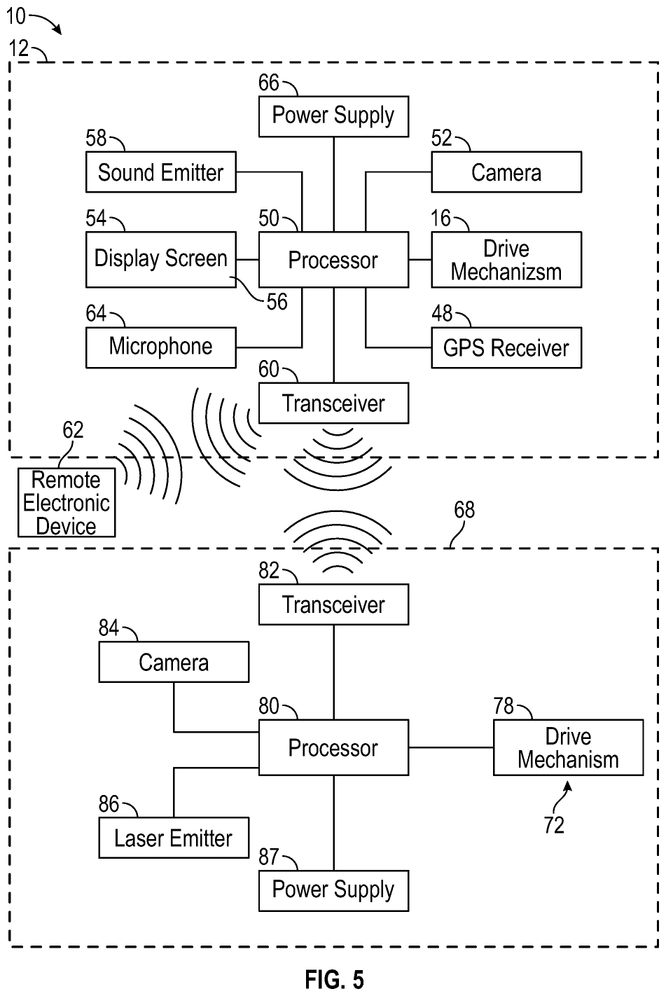

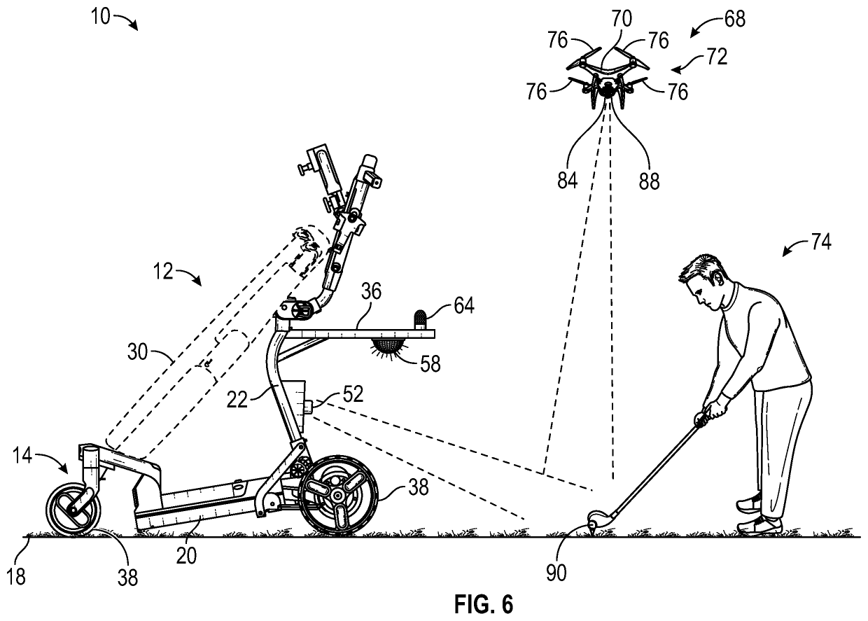

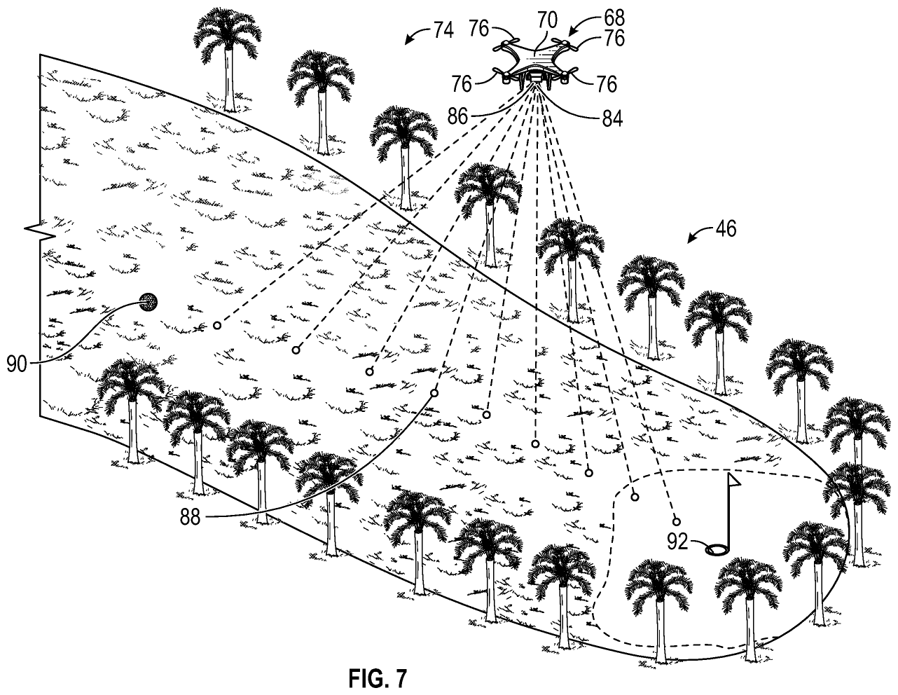

With reference now to the drawings, and in particular to FIGS. 1 through 7 thereof, a new golf caddy system embodying the principles and concepts of an embodiment of the disclosure and generally designated by the reference numeral 10 will be described.

As best illustrated in FIGS. 1 through 7, the golf caddy system 10 generally comprises a cart 12 with a frame 14 and a cart drive mechanism 16 with is operable to move the cart 12 across a ground surface 18. The frame 14 comprises a base 20 and a post 22, in which the post 22 is coupled to a front end 24 of the base 20 and extends upwardly from the base 20. The base 20 has an upper surface 26 which is spaced from the post 22 and is configured for supporting a bottom end 32 of a golf bag 30. The post 22 has a rear surface 28 which is configured for supporting a front side 34 of the golf bag 30. The frame 14 also includes a platform 36 which is coupled to and extends forwardly with respect to the post 22. The cart drive mechanism 16 comprises a plurality of wheels 38 and a pair of wheel motors 44. Each wheel 38 is rotatably coupled to the frame 14 and is positioned such that the plurality of wheels 38 is configured for supporting the frame 14 on the ground surface 18. The plurality of wheels 38 includes a pair of front wheels 40 and a pair of rear wheels 42, and each rear wheel 42 of the pair of rear wheels 42 is a caster wheel. Each wheel motor 44 of the pair of wheel motors 44 is operatively coupled to a respective front wheel 40 of the pair of front wheels 40. The cart 12 may be steered by rotating each front wheel 40 at different velocities. The cart 12 may also be steered by a steering linkage and a steering drive attached to at least one of the plurality of wheels 38.

A cart processor 50 with a memory is mounted to the frame 14 and is electrically coupled to the cart drive mechanism 16. A map data is stored on the memory and includes location and topographical information of a golf course 46. A global positioning system (GPS) receiver 48 is electrically coupled to the cart processor 50 and is configured to determine a current location of the cart 12. The cart processor 50 is configured to cause the cart drive mechanism 16 to move the cart 12 to a selected location on the golf course 46 based on the map data and the current location of the cart 12. The map data may include locations of components of each golf hole including tee boxes, fairways, hazards, greens, cups, and the like. The map data may also include locations of other landmarks found on the golf course 46 such as a club house, a pro shop, and the like.

A cart camera 52 is coupled to the frame 14 and is electrically coupled to the cart processor 50. The cart camera 52 is configured to capture a first video of a golf swing, which the cart processor 50 selectively stores in the memory. The cart processor 50 is configured for analyzing the first video to determine a landing location on the golf course 46 of a struck golf ball based on the map data and the current location of the cart 12. The cart processor 50 is also configured for analyzing the first video to determine swing information. The swing information may include club speed, golfer stance, point of impact on the golf ball, path of the golf ball, and the like. The cart processor 50 is also programmed to analyze the swing information to determine golfer advice. The golfer advice may include suggestions for improving a golfer's swing, club selection advice, suggested path of a putt, and the like.

A display screen 54 is mounted to the frame 14 and is electrically coupled to the cart processor 50. The cart processor 50 is configured to cause the display screen 54 to display the swing information and the golfer advice. The display screen 54 comprises a touchscreen 56 configured for receiving touch commands for controlling the cart processor 50. A sound emitter 58 is coupled to the frame 14 and is electrically coupled to the cart processor 50. The cart processor 50 is configured to cause the sound emitter 58 to audibly convey the swing information and the golfer advice.

A cart transceiver 60 is electrically coupled to the cart processor 50 and is configured to wirelessly communicate with a remote electronic device 62 such as a phone, a tablet, a computer, or the like. The cart processor 50 is configured to cause the cart transceiver 60 to transmit the swing information and the golfer advice to the remote electronic device 62, and the cart transceiver 60 is configured for receiving instructions from the remote electronic device 62. A microphone 64 is electrically coupled to the cart processor 50 and is mounted to the frame 14. The microphone 64 is configured for receiving audio commands for controlling the cart processor 50. A cart power supply 66 is electrically coupled to the cart processor 50 and comprises a battery.

An unmanned air vehicle (UAV) 68 is in wireless communication with the cart 12 and is removably positioned on the platform 36 of the frame 14 of the cart 12. The UAV 68 comprises a body 70 and a UAV drive mechanism 72 that is coupled to the body 70 and is operable to move the UAV 68 through an air volume 74 positioned above the ground surface 18. The UAV drive mechanism 72 comprises a plurality of rotors 76 and a rotor motor assembly 78. Each rotor 76 of the plurality of rotors 76 is rotatably coupled to the body 70 and is shaped and oriented to generate upward thrust. The rotor motor assembly 78 is operatively coupled to each rotor 76 of the plurality of rotors 76.

A UAV processor 80 is mounted to the body 70 and is electrically coupled to the UAV drive mechanism 72. A UAV transceiver 82 is electrically coupled to the UAV processor 80 and is in wireless communication with the cart transceiver 60. The cart transceiver 60 selectively transmits instructions to the UAV transceiver 82.

A UAV camera 84 is coupled to the body 70 and is electrically coupled to the UAV processor 80. The UAV camera 84 is configured to capture a second video of the golf swing, which the cart processor 50 selectively stores in the memory. One of the cart processor 50 and the UAV processor 80 is configured for analyzing the second video to determine the landing location of the struck on the golf course 46 golf ball based on the map data and the current location of the cart 12. One of the cart processor 50 and the UAV processor 80 is also configured for analyzing the second video to determine the swing information.

A UAV laser emitter 86 is coupled to the body 70 and is electrically coupled to the UAV processor 80. The UAV laser emitter 86 is configured to emit a laser along a path 88 positioned at a junction between the ground surface 18 and a vertical plane extending between a ball 90 lying on the ground surface 18 and a target hole 92 in the ground surface 18. A UAV power supply 87 is electrically coupled to the UAV processor 80 and comprises a battery. The UAV 68 is operable to determine the topographical information of the golf course 46 by moving through the air volume 74 via the UAV drive mechanism 72, recording a course video of the golf course 46 via the UAV camera 84, and analyzing the course video via the UAV processor 80.

The golf caddy system 10 may also record game data such as game scores for various types of golf games and various numbers of players. Distinct swing information for multiple players may be recorded, and the different swing information may be stored or transmitted to separate remote electronic devices 62. Game information may be inputted via the touchscreen 56, the microphone 64, one of the separate remote electronic devices 62, or other input means. Game information may also be automatically retrieved via at least one of the cart camera 52 and the UAV camera 84.

In use, the golf caddy system 10 may be operated to follow one or more golfers on a golf course 46 to perform various functions. The golf caddy system 10 records videos of the one or more golfers' golf swings and analyzes them to determine the swing information and develop the golfer advice. The UAV 68 is operable via the cart processor 50 to record video, determine the topographical information of the golf course 46, and emit the laser along the path 88 as described. The UAV 68 may also be operable independent of the cart processor 50 via an alternate controller.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A golf caddy system comprising a cart, the cart comprising:
a frame;
a cart drive mechanism being coupled to the frame and being operable to move the cart across a ground surface;
a cart processor being mounted to the frame and being electrically coupled to the cart drive mechanism, the cart processor having a memory;
a map data being stored on the memory and including location and topographical information of a golf course;
a global positioning system (GPS) receiver being electrically coupled to the cart processor, the GPS receiver being configured to determine a current location of the cart;
wherein the cart processor is configured to cause the cart drive mechanism to move the cart to a selected location on the golf course based on the map data and the current location of the cart; and
a cart camera being coupled to the frame, the cart camera being electrically coupled to the cart processor, the cart camera being configured to capture a first video of a golf swing.

2. The system of claim 1, wherein the frame comprises a base and a post, the post being coupled to a front end of the base, the post extending upwardly from the base, the base having an upper surface spaced from the post, the upper surface being configured for supporting a bottom end of a golf bag, the post having a rear surface being configured for supporting a front side of the golf bag.

3. The system of claim 1 wherein the cart drive mechanism comprises:
a plurality of wheels being rotatably coupled to the frame, the plurality of wheels being positioned such that the plurality of wheels is configured for supporting the frame on the ground surface, the plurality of wheels including a pair of front wheels and a pair of rear wheels, each rear wheel of the pair of rear wheels being a caster wheel; and
a pair of wheel motors, each wheel motor of the pair of wheel motors being operatively coupled to a respective front wheel of the pair of front wheels.

4. The system of claim 1, wherein the cart processor selectively stores the first video in the memory.

5. The system of claim 1, wherein the cart processor is configured for analyzing the first video to determine a landing location on the golf course of a struck golf ball based on the map data and the current location of the cart.

6. The system of claim 1, wherein the cart processor is configured for analyzing the first video to determine swing information.

7. The system of claim 6, wherein the cart processor is configured to analyze the swing information to determine golfer advice.

8. The system of claim 7, wherein the cart further comprises a display screen being mounted to the frame and being electrically coupled to the cart processor, the cart processor being configured to cause the display screen to display the swing information and the golfer advice.

9. The system of claim 8, wherein the display screen comprises a touchscreen configured for receiving touch commands for controlling the cart processor.

10. The system of claim 7, wherein the cart further comprises a sound emitter being coupled to the frame and being electrically coupled to the cart processor, the cart processor being configured to cause the sound emitter to audibly convey the swing information and the golfer advice.

11. The system of claim 7, wherein the cart further comprises a cart transceiver being electrically coupled to the cart processor, the cart transceiver being configured to wirelessly communicate with a remote electronic device, the cart processor being configured to cause the cart transceiver to transmit the swing information and the golfer advice to the remote electronic device, the cart transceiver being configured for receiving instructions from the remote electronic device.

12. The system of claim 1, wherein the cart further comprises a microphone being electrically coupled to the cart processor and being mounted to the frame, the microphone being configured for receiving audio commands for controlling the cart processor.

13. The system of claim 1, wherein the cart further comprises a cart power supply being electrically coupled to the cart processor, the cart power supply comprising a battery.

14. The system of claim 1, further comprising an unmanned air vehicle (UAV) being in wireless communication with the cart, the UAV comprising:
a body;
a UAV drive mechanism being coupled to the body and being operable to move the UAV through an air volume positioned above the ground surface;
a UAV processor being mounted to the body and being electrically coupled to the UAV drive mechanism;
a UAV transceiver being electrically coupled to the UAV processor, the UAV transceiver being in wireless communication with the cart transceiver, the cart transceiver selectively transmitting instructions to the UAV transceiver; and
a UAV camera being coupled to the body and being electrically coupled to the UAV processor, the UAV camera being configured to capture a second video of the golf swing, the cart processor selectively storing the second video in the memory, one of the cart processor and the UAV processor being configured for analyzing the second video to determine the landing location of the struck golf ball on the golf course based on the map data and the current location of the cart, one of the cart processor and the UAV processor being configured for analyzing the second video to determine the swing information.

15. The system of claim 14, wherein the UAV further comprises a UAV laser emitter being coupled to the body and being electrically coupled to the UAV processor, the UAV laser emitter being configured to emit a laser along a path positioned at a junction between the ground surface and a vertical plane extending between a ball lying on the ground surface and a target hole in the ground surface.

16. The system of claim 14, wherein the UAV drive mechanism comprises:
a plurality of rotors, each rotor of the plurality of rotors being rotatably coupled to the body and being shaped and oriented to generate upward thrust; and
a rotor motor assembly being operatively coupled to each rotor of the plurality of rotors.

17. The system of claim 14, wherein the UAV is operable to determine the topographical information of the golf course by moving through the air volume via the UAV drive mechanism, recording a course video of the golf course via the UAV camera, and analyzing the course video via the UAV processor.

18. The system of claim 14, wherein the frame of the cart comprises a base and a post, the post being coupled to a front end of the base, the post extending upwardly from the base, the base having an upper surface spaced from the post, the upper surface being configured for supporting a bottom end of a golf bag, the post having a rear surface being configured for supporting a front side of the golf bag, the frame including a platform, the platform being coupled to and extending forwardly with respect to the post, the UAV being removably positioned on the platform of the frame of the cart.

19. The system of claim 14, wherein the UAV further comprises a UAV power supply being electrically coupled to the UAV processor, the UAV power supply comprising a battery.

20. A golf caddy system comprising:
a cart comprising:
a frame comprising a base and a post, the post being coupled to a front end of the base, the post extending upwardly from the base, the base having an upper surface spaced from the post, the upper surface being configured for supporting a bottom end of a golf bag, the post having a rear surface being configured for supporting a front side of the golf bag, the frame including a platform, the platform being coupled to and extending forwardly with respect to the post;
a cart drive mechanism being coupled to the frame and being operable to move the cart across a ground surface, the cart drive mechanism comprising:
a plurality of wheels being rotatably coupled to the frame, the plurality of wheels being positioned such that the plurality of wheels is configured for supporting the frame on the ground surface, the plurality of wheels including a pair of front wheels and a pair of rear wheels, each rear wheel of the pair of rear wheels being a caster wheel; and
a pair of wheel motors, each wheel motor of the pair of wheel motors being operatively coupled to a respective front wheel of the pair of front wheels;
a cart processor being mounted to the frame and being electrically coupled to the cart drive mechanism, the cart processor having a memory;
a map data being stored on the memory and including location and topographical information of a golf course;
a global positioning system (GPS) receiver being electrically coupled to the cart processor, the GPS receiver being configured to determine a current location of the cart;
wherein the cart processor is configured to cause the cart drive mechanism to move the cart to a selected location on the golf course based on the map data and the current location of the cart;
a cart camera being coupled to the frame, the cart camera being electrically coupled to the cart processor, the cart camera being configured to capture a first video of a golf swing, the cart processor selectively storing the first video in the memory, the cart processor being configured for analyzing the first video to determine a landing location on the golf course of a struck golf ball based on the map data and the current location of the cart, the cart processor being configured for analyzing the first video to determine swing information;
wherein the cart processor is configured to analyze the swing information to determine a golfer advice;
a display screen being mounted to the frame and being electrically coupled to the cart processor, the cart processor being configured to cause the display screen to display the swing information and the golfer advice, the display screen comprising a touchscreen configured for receiving touch commands for controlling the cart processor;
a sound emitter being coupled to the frame and being electrically coupled to the cart processor, the cart processor being configured to cause the sound emitter to audibly convey the swing information and the golfer advice;
a cart transceiver being electrically coupled to the cart processor, the cart transceiver being configured to wirelessly communicate with a remote electronic device, the cart processor being configured to cause the cart transceiver to transmit the swing information and the golfer advice to the remote electronic device, the cart transceiver being configured for receiving instructions from the remote electronic device;
a microphone being electrically coupled to the cart processor and being mounted to the frame, the microphone being configured for receiving audio commands for controlling the cart processor; and
a cart power supply being electrically coupled to the cart processor, the cart power supply comprising a battery;
an unmanned air vehicle (UAV) being in wireless communication with the cart, the UAV being removably positioned on the platform of the frame of the cart, the UAV comprising:
a body;
a UAV drive mechanism being coupled to the body and being operable to move the UAV through an air volume positioned above the ground surface, the UAV drive mechanism comprising:
a plurality of rotors, each rotor of the plurality of rotors being rotatably coupled to the body and being shaped and oriented to generate upward thrust; and
a rotor motor assembly being operatively coupled to each rotor of the plurality of rotors;
a UAV processor being mounted to the body and being electrically coupled to the UAV drive mechanism;
a UAV transceiver being electrically coupled to the UAV processor, the UAV transceiver being in wireless communication with the cart transceiver, the cart transceiver selectively transmitting instructions to the UAV transceiver;
a UAV camera being coupled to the body and being electrically coupled to the UAV processor, the UAV camera being configured to capture a second video of the golf swing, the cart processor selectively storing the second video in the memory, one of the cart processor and the UAV processor being configured for analyzing the second video to determine the landing location of the struck golf ball on the golf course based on the map data and the current location of the cart, one of the cart processor and the UAV processor being configured for analyzing the second video to determine the swing information;
a UAV laser emitter being coupled to the body and being electrically coupled to the UAV processor, the UAV laser emitter being configured to emit a laser along a path positioned at a junction between the ground surface and a vertical plane extending between a ball lying on the ground surface and a target hole in the ground surface; and
a UAV power supply being electrically coupled to the UAV processor, the UAV power supply comprising a battery; and
wherein the UAV is operable to determine the topographical information of the golf course by moving through the air volume via the UAV drive mechanism, recording a course video of the golf course via the UAV camera, and analyzing the course video via the UAV processor.
